(19) United States
(12) Patent Application Publication
(10) Pub. No.: US 2016/0085799 A1
(43) Pub. Date: Mar. 24, 2016

(54) METHOD AND SYSTEM FOR CORRECTING ERROR OF KNOWLEDGE INVOLVED QUERY

(71) Applicants: Taeil KIM, Seongnam-si (KR); Do Youn KIM, Seongnam-si (KR); Kwang Hyun KIM, Seongnam-si (KR); Dae Neung SOHN, Seongnam-si (KR)

(72) Inventors: Taeil KIM, Seongnam-si (KR); Do Youn KIM, Seongnam-si (KR); Kwang Hyun KIM, Seongnam-si (KR); Dae Neung SOHN, Seongnam-si (KR)

(21) Appl. No.: 14/858,017

(22) Filed: Sep. 18, 2015

(30) Foreign Application Priority Data
Sep. 19, 2014 (KR) 10-2014-0124709

(51) Int. Cl. G06F 17/30

(52) U.S. Cl. CPC G06F 17/30389; G06F 17/30864

(57) ABSTRACT

Provided is a method and system for correcting a knowledge error in a search query. A method of correcting a knowledge error in a search query may include generating a recommended search query for a plurality of domains by combining at least one search term from each of a plurality of vocabulary sets, each of the plurality of vocabulary sets associated with a respective domain, verifying the recommended search query based on a reliability factor of the recommended search query, and generating, for each domain, a knowledge error correction rule for correcting a knowledge error indicating an error of a concept or information, with respect to the verified recommended search query.

### CROSS-REFERENCE TO RELATED APPLICATION

This application claims priority from and the benefit of Korean Patent Application No. 10-2014-0124709, filed on Sep. 19, 2014 in the Korean Intellectual Property Office (KIPO), the disclosure of which is incorporated herein in its entirety by reference.

### BACKGROUND

1. Field

Various example embodiments relate to technologies for providing a recommended search query by correcting a knowledge error included in a search query.

2. Description of the Background

A search engine refers to software and/or a website service that helps a user to easily retrieve data on the Internet. The search engine searches a database using a search query input received from a user, extracts a search result corresponding to the search query, and provides the search result to the user. The search engine extracts, from the database, the search result that matches the search query transmitted from the user terminal through a search page, software application (e.g., a smart device app), etc., generates search results (e.g., a search result page), and provides the search results (e.g., search result page) to the user terminal.

When an error is present in the search query, the search engine provides an inaccurate search result to the user. A search keyword recommending service may be provided to the user to provide an accurate search result regardless of the error in the search query. The search keyword recommending service may correct a mistyped letter or a grammatical error included in the search query.

However, even with the absence of a mistyped letter or a grammatical error in a search query, the existing search engine will provide an inaccurate search result when the search query includes a knowledge error (e.g., a factual mistake or misunderstanding) indicating a concept and/or information that is different than the actual information sought by the user. Due to the inaccurate search result, a user may conduct a re-search or may need to find additional information to conduct the re-search.

### SUMMARY

Some example embodiments provide a method and/or system for correcting a knowledge error in a search query that may provide an accurate search query to a user by correcting the search query input from the user to be a recommended search query that is indicated as more accurate (e.g., more likely to provide the search results that the user intended to search for) than the user's initial search query input, that is, correct information and/or concept although the input search query includes a knowledge error different from the actual information or concept sought by the user.

Some example embodiments also provide a method and/or system for correcting a knowledge error in a search query that may solve and/or remedy an inconvenience suffered by a user from performing a re-search and may reduce the search time of the user by correcting a knowledge error present in an error of information and/or concept and by providing a recommended search query in which the knowledge error is corrected.

According to at least one example embodiment, there is provided a method of correcting a knowledge error in a search query, the method executed on at least one computer, the computer including at least one processor, the method including generating, using the at least one processor, a recommended search query for a plurality of domains by combining at least one search keyword from each of a plurality of vocabulary sets, each of the plurality of vocabulary sets associated with a respective domain, verifying, using the at least one processor, the recommended search query based on a reliability factor of the recommended search query, and generating, for each domain, using the at least one processor, a knowledge error correction rule for correcting a knowledge error indicating an error of a concept or information, with respect to the verified recommended search query.

The knowledge error correcting method may further include receiving, using the at least one processor, a search query, and providing using the at least one processor, a recommended search query in which the knowledge error is corrected based on the knowledge error correction rule, in response to the received search query including the knowledge error.

The verifying of the recommended search query may include calculating, using the at least one processor, a reliability factor of a candidate recommended search query generated by combining the at least one search keyword from each of the plurality of vocabulary sets and the reliability factor of the recommended search query, verifying, using the at least one processor, the recommended search query based on the reliability factor of the recommended search query, and expanding, using the at least one processor, the candidate recommended search query to the recommended search query by generating a result based on the reliability factor of the candidate recommended search query and the reliability factor of the recommended search query.

The expanding of the candidate recommended search query to the recommended search query may include expanding the candidate recommended search query to the recommended search query in response to the reliability of the recommended search query being greater than the reliability of the recommended search query.

The generating of the recommended search query may include expanding the recommended search query in response to normalizing a functional language corresponding to the recommended search query.

The reliability of the recommended search query may be calculated based on at least one of a search result display frequency, a search query click frequency, and a search frequency corresponding to the recommended search query.

According to at least one example embodiment, there is provided a method of correcting a knowledge error in a search query, the method executed on at least one computer, the computer including at least one processor, the method including receiving, using the at least one processor, a search query, and displaying, on a search engine service user interface screen, a recommended search query in which a knowledge error is corrected based on a generated knowledge error correction rule, in response to the received search query including the knowledge error indicating an error of a concept or information.

The knowledge error correcting method may further include generating, using the at least one processor, a recommended search query for a plurality of domains by combining at least one search keyword from each of a plurality of vocabulary sets, each of the plurality of vocabulary sets associated with a respective domain, verifying, using the at least one processor, the recommended search query based on a reliability factor of the recommended search query, and generating, for each domain, using the at least one processor, the knowledge error correction rule for correcting the knowledge error, with respect to the verified recommended search query.

The verifying of the recommended search query may include calculating, using the at least one processor, a reliability factor of a candidate recommended search query generated by combining the at least one search keyword from each of the plurality of vocabulary sets and the reliability factor of the recommended search query, verifying, using the at least one processor, the recommended search query based on the reliability factor of the recommended search query, and expanding, using the at least one processor, the candidate recommended search query to the recommended search query based on the reliability factor of the candidate recommended search query and the reliability factor of the recommended search query.

The displaying may include displaying the received search query together with the recommended search query on the search engine service user interface screen.

According to at least one example embodiment, there is provided a system for correcting a knowledge error in a search query, the system including a memory having computer readable instructions stored thereon, and at least one processor configured to execute the computer readable instructions to generate a recommended search query for a plurality of domains by combining at least one search keyword from each of a plurality of vocabulary sets, each of the plurality of vocabulary sets associated with a respective domain, verify the recommended search query based on a reliability factor of the recommended search query, and generate, for each domain, a knowledge error correction rule for correcting a knowledge error indicating an error of a concept or information, with respect to the verified recommended search query.

The at least one processor may be further configured to execute the computer readable instructions to receive a search query, and provide a recommended search query in which the knowledge error is corrected based on the knowledge error correction rule, in response to the received search query including the knowledge error.

According to at least one example embodiment, there is provided a file distribution system to distribute a file of an application installed in a user terminal, the file distribution system may include a file transmitter configured to transmit the file in response to a user request, and an application installed on a user terminal, the application including computer readable instructions that, when executed by at least one processor included in the user terminal, configure the user terminal to generate a recommended search query for a plurality of domains by combining at least one search keyword from each of a plurality of vocabulary sets, each of the plurality of vocabulary sets associated with a respective domain, verify the recommended search query based on a reliability factor of the recommended search query, and generate, for each domain, a knowledge error correction rule for correcting a knowledge error indicating an error of a concept or information, with respect to the verified recommended search query.

The computer readable instructions of the application, when executed by the at least one processor included in the user terminal, may further configure the user terminal to receive a search query, and provide a recommended search query in which the knowledge error is corrected based on the knowledge error correction rule, in response to the received search query including the knowledge error.

It is to be understood that both the foregoing general description and the following detailed description are explanatory and are intended to provide further explanation of the example embodiments as claimed.

### BRIEF DESCRIPTION OF THE DRAWINGS

The foregoing and other features of the example embodiments will be apparent from the more particular description of non-limiting example embodiments, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a diagram illustrating a relationship between a user terminal and a knowledge error correcting system for correcting a knowledge error in a search query according to at least one example embodiment.

FIG. 2 is a block diagram illustrating a configuration of a knowledge error correcting system according to at least one example embodiment.

FIG. 3 is a flowchart illustrating a knowledge error correcting method according to at least one example embodiment.

FIG. 4 is a flowchart illustrating an operation of providing a recommended search query in which a knowledge error is corrected based on a knowledge error correcting method according to at least one example embodiment.

FIG. 5 illustrates an operation of generating a recommended search query by combining vocabularies included in a database according to at least one example embodiment.

FIG. 6 illustrates an operation of generating a candidate recommended search query by combining vocabularies included in a database according to at least one example embodiment.

FIG. 7 illustrates an operation of generating a knowledge error correction rule according to at least one example embodiment.

FIG. 8 illustrates an example of providing a recommended search query by correcting a knowledge error included in a search query according to at least one example embodiment.

FIG. 9 is a block diagram illustrating an example of a configuration of a computer system according to at least one example embodiment.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of the example embodiments to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first,” “second,” etc., may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein

Hereinafter, various example embodiments will be described with reference to the accompanying drawings.

At least one example embodiment may be applicable to a search engine system that provides a search result corresponding to a search query of a user. For example, some example embodiments may be applicable to an information search service of a search engine.

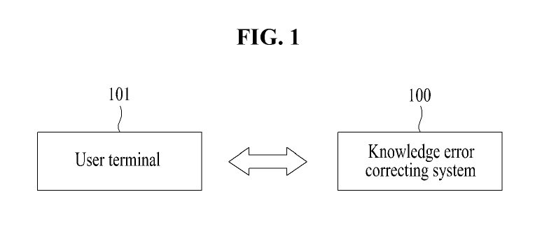

FIG. 1 is a diagram illustrating a relationship between a user terminal and a system (hereinafter, a knowledge error correcting system) for correcting a knowledge error in a search query according to some example embodiments. FIG. 1 illustrates a knowledge error correcting system 100 and a user terminal 101. In FIG. 1, an indicator with arrowheads indicates that data may be transmitted and received between the knowledge error correcting system 100 and the user terminal 101. While only a single user terminal 101 is illustrated in FIG. 1, the example embodiments are not limited thereto and more than one user terminal may connect to/communicate with the knowledge error correcting system 100.

The user terminal 101 may refer to any type of terminal devices, for example, a personal computer (PC), a laptop, a smartphone, a tablet, a smart device, a wearable computer, a PDA, etc., capable of connecting to a website/mobile site associated with the knowledge error correcting system 100 and/or installing and executing a service exclusive application (e.g., a computer program, a web applet, a smart device app, a widget, etc.). Here, the user terminal 101 may perform the overall service operation, such as providing a search engine service user interface screen configuration, a data input, a data transmission and reception, a data storage, or the like, under the control of the website/mobile site or the exclusive application.

The knowledge error correcting system 100 serves as a search engine that provides a search result corresponding to a search query input from a user. In particular, when a knowledge error is included in the search query, the knowledge error correcting system 100 may provide a recommended search query in which the knowledge error is corrected and a search result corresponding to the recommended search query. Here, the knowledge error may indicate inaccurate, for example, wrong information or a concept different from the information or a concept that the user is aware of and/or intended to submit in the search request.

In an example in which “region A cinema 1” is input as a search query and cinema 1 is absent in region A, the search query may be determined to include a knowledge error.

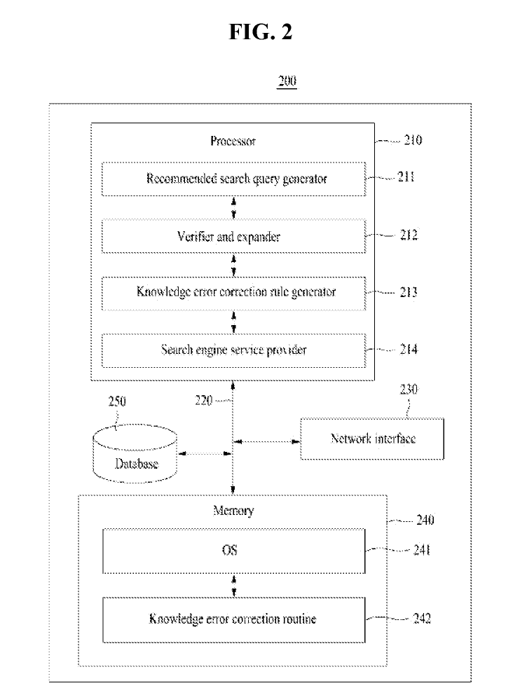

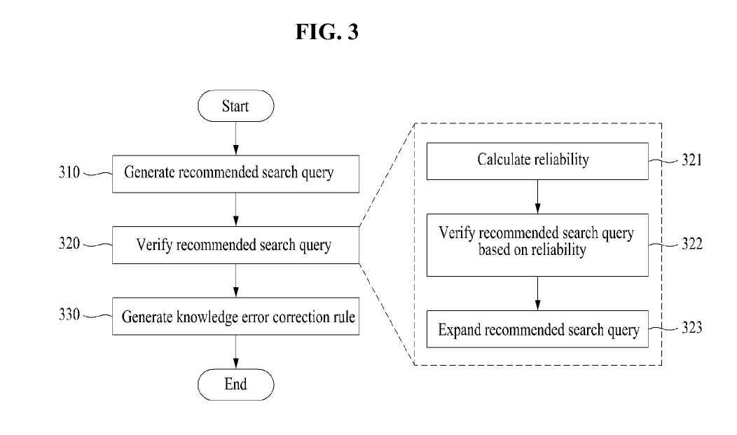

FIG. 2 is a block diagram illustrating a configuration of a knowledge error correcting system according to some example embodiments, and FIG. 3 is a flowchart illustrating a knowledge error correcting method according to some example embodiments.

Referring to FIG. 2, the knowledge error correcting system 200 may include one or more computing devices, such as a server, that include at least one processor 210, a bus 220, a network interface 230, a memory 240, and a database 250, etc. The memory 240 may include an operating system (OS) 241 and a knowledge error correction routine 242. The processor 210 may include computer readable instructions for specially programming the processor 210 as a recommended search query generator 211, a verifier and expander 212, a knowledge error correction rule generator 213, and/or a search engine service provider 214. According to other example embodiments, the knowledge error correcting system 200 may include a greater or lesser number of constituent elements than the number of constituent elements shown in FIG. 2. For example, the knowledge error correcting system 200 may include other constituent elements such as a display, a transceiver, etc.

The memory 240 may include a permanent mass storage device, such as a random access memory (RAM), a read only memory (ROM), a disc drive, a solid state drive, an optical drive, etc., as a computer-readable storage medium. Also, program codes (e.g., computer readable instructions) for the OS 241, the knowledge error correction routine 242, the computer readable instructions associated with the recommended search query generator 211, the verifier and expander 212, the knowledge error correction rule generator 213, and/or the search engine service provider 214, etc., may be stored in the memory 240. Such software constituent elements may be loaded from another computer-readable storage medium separate from the memory 240 using a drive mechanism (not shown). The other computer-readable storage medium may include, for example, a floppy drive, a disc, a tape, a DVD/CD-ROM drive, a memory card, etc. Software constituent elements may be loaded to the memory 240 through the network interface 230 instead of, or in addition to, the computer-readable storage medium.

The database 250 may store and retain data and/or information associated with the search engine, user submitted search queries, search results, etc. While the database 250 is illustrated in FIG. 2 as being a constituent element of the knowledge error correcting system 200, the example embodiments are not limited thereto and the database 250 may be implemented on the memory 240, or the whole or a portion of the database 250 may be implemented using external databases constructed on a separate server, or on other, separate knowledge error correcting systems.

The bus 220 enables communication and data transmission between the constituent elements of the knowledge error correcting system 200. The bus 220 may be configured using a high-speed serial bus, a parallel bus, a storage area network (SAN), and/or another appropriate communication technology.

The network interface 230 may be a computer hardware constituent element for connecting the knowledge error correcting system 200 to the computer network. The network interface 230 may connect the knowledge error correcting system 200 to the computer network through a wireless and/or wired connection.

The processor 210 may be configured to process computer-readable instructions of a computer program by performing a basic arithmetic operation, a logic operation, and an input/output operation of the knowledge error correcting system 200. The computer-readable instructions may be provided from the memory 240 and/or the network interface 230 to the processor 210 through the bus 220. The processor 210 may be configured to execute program codes for the recommended search query generator 211, the verifier and expander 212, the knowledge error correction rule generator 213, and/or the search engine service provider 214. The program codes may be stored in a storage device such as the memory 240.

When executed by a processor, such as the processor 210, the computer-readable instructions associated with the recommended search query generator 211, the verifier and expander 212, the knowledge error correction rule generator 213, and/or the search engine service provider 214 transform the processor 210 into a special purpose processor configured to perform at least the operations 310 through 330 of FIG. 3.

Referring to FIG. 3, in operation 310, the recommended search query generator 211 may generate a recommended search query for each domain by combining “vocabularies” included in the database 250. The “vocabularies” are a plurality of vocabulary keyword sets associated with various topics, knowledge information sets, etc., that are stored in the database 250 and are used by the search engine to provide search results.

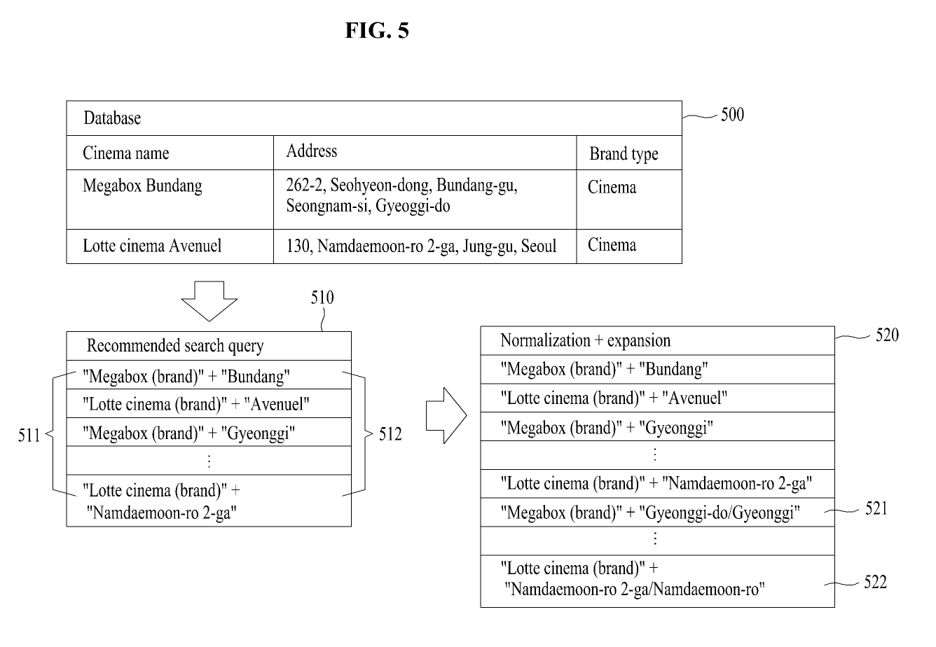

For example, the recommended search query generator 211 may generate a recommended search query by combining a vocabulary 1 from vocabulary set 1 (e.g., a brand, an idea, a fact, or a similar concept) and vocabulary 2 from vocabulary set 2 (e.g., a region name, a second idea, a second fact, or a second similar concept) that are included in the database 250. An operation of generating a recommended search query will be further described with reference to FIG. 5.

Here, the database 250 may refer to any type of database constructed for various fields so that a search engine may provide a search result of data to be retrieved. For example, the database may include a database that includes information collected in association with brands such as entertainment providers (e.g., cinemas, amusement parks, recreational areas, etc.), various types of shopping options (e.g., shopping franchises, shopping malls, etc.), locations, products, goods, services, etc., a database that includes information collected in association with people (e.g., celebrities and/or famous people, such as singers, actors, athletes, politicians, business leaders, national figures, etc.), a database that includes information collected in association with content (e.g., television programs, movies, music, Internet videos, books, stories, blogs, etc.).

In operation 320, the verifier and expander 212 may verify the recommended search query based on a reliability factor of the recommended search query.

In operation 321, the verifier and expander 212 may calculate the reliability factor of the recommended search query based on at least one of a search result display frequency, a search query click frequency (e.g., how often a search query is used by users of the search engine), and a search frequency corresponding to the recommended search query.

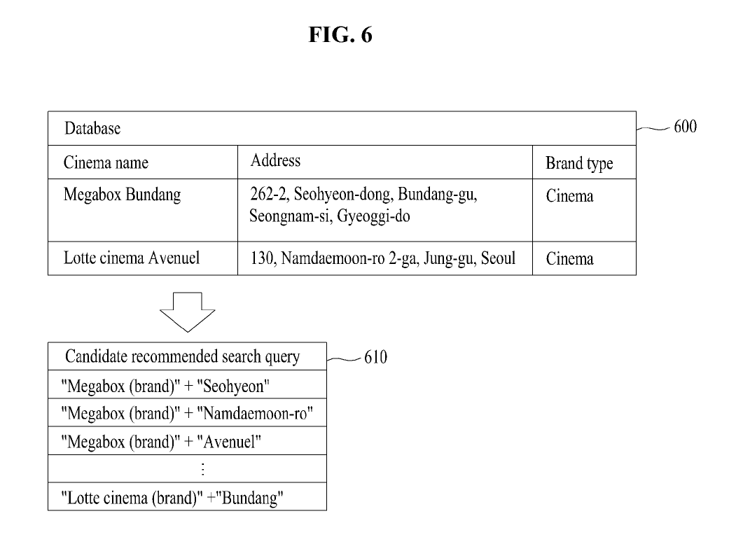

Also, the verifier and expander 212 may calculate a reliability factor of a candidate recommended search query generated by combining vocabularies (e.g., the plurality of vocabulary keyword sets associated with various topics, knowledge information sets, etc.) included in the database 250. Here, the candidate recommended search query may be generated by combining vocabularies included in the database 250 based on a search query log indicating a search query history input from users into the search engine. An operation of generating the candidate recommended search query will be described with reference to FIG. 6.

For example, the verifier and expander 212 may calculate reliabilities factors for the recommended search query and the candidate recommended search query according to Equation 1.

$$Score ( {W}_{1} … {W}_{k} , {W}_{rep} ) = α * \frac{rs ( {W}_{1} … {W}_{k} , {W}_{rep} )}{rs ( {W}_{1} … {W}_{k} )} + β * \frac{cl ( {W}_{1} … {W}_{k} , {W}_{rep} )}{cl ( {W}_{1} … {W}_{k} )} + γ * \frac{cl ( {W}_{1} … {W}_{k} , {W}_{rep} )}{qc ( {W}_{1} … {W}_{k} )} \qquad [ Equation 1 ]$$

In Equation 1, W₁ . . . Wₖ denote correct information in the search query input, in other words, vocabulary that does not need to be corrected, Wᵣₑₚ denotes vocabulary that is likely to be wrong information, rs( ) denotes a search result display frequency of a corresponding vocabulary combination, cl( ) denotes a search result click frequency of the corresponding vocabulary combination, and qc( ) denotes a search frequency of the corresponding vocabulary combination. Further, α, β, and γ denote weights may be set to be equal to one another, or may be set to differ from one another based on importance thereof.

In operation 322, the verifier and expander 212 may verify the recommended search query based on the calculated reliability factor of the recommended search query.

For example, the verifier and expander 212 may generate a result based on the reliability factor of the recommended search query and the reliability factor of the recommended search query and then expand the candidate recommended search query to the recommended search query in response to the results. In other words, when a reliability factor of a recommended search query is calculated to be greater than or equal to a desired verification reliability factor, the verifier and expander 212 may verify that the recommended search query is correct information based on facts. For example, when the recommended search query is “region A cinema 2” and has a reliability factor greater than or equal to the verification reliability, the verifier and expander 212 may verify that cinema 2 is actually located in region A.

In operation 323, the verifier and expander 212 may expand the recommended search query based on the reliability factor of the recommended search query and the reliability factor of the candidate recommended search query.

For example, when a reliability factor of a candidate recommended search query is greater than a reliability factor of a recommended search query within the same domain, the verifier and expander 212 may perform an expansion operation by adding the candidate recommended search query to the recommended search query. For example, when a plurality of recommended search queries is present, the verifier and expander 212 may compare a reliability factor of a recommended search query to the average reliability factor of the recommended search queries. As a result, when the reliability factor of the candidate recommended search query is greater than (or equal to) a desired threshold, such as the average reliability factor of the recommended search queries, the verifier and expander 212 may expand the candidate recommended search query to be a recommended search query. In addition, when a reliability factor of a candidate recommended search query is greater than (or equal to) a reliability factor of a recommended search query having a desired characteristic reliability factor, such as having the lowest reliability factor among a plurality of recommended search queries, the verifier and expander 212 may expand the candidate recommended search query to be a recommended search query.

In operation 330, the knowledge error correction rule generator 213 may generate, for each domain, a knowledge error correction rule for correcting the knowledge error, with respect to the verified and expanded recommended search query.

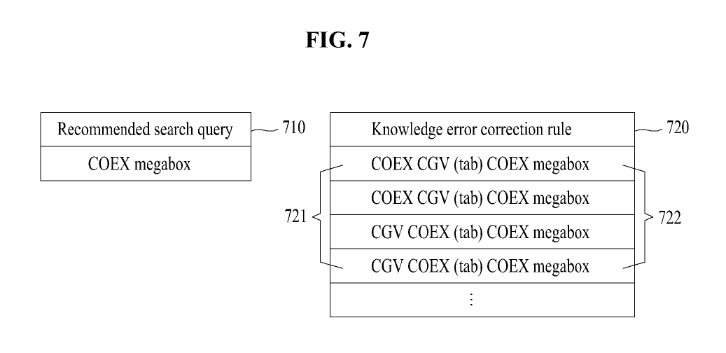

For example, the knowledge error correction rule generator 213 may verify, for each domain, a vocabulary that is estimated to have been input from the user due to erroneous recognition among vocabularies included in the recommended search query, and may generate a rule of generating a wrong answer and correcting the wrong answer to a correct answer. Here, an operation of generating the knowledge error correction rule will be described with reference to FIG. 7.

As described above with reference to FIGS. 2 and 3, a search query recommending database 250 that includes a recommended search query for correcting a knowledge error included in a search query by combining vocabularies included in the database 250 may be constructed. To correct an inaccurate search query input, for example, a search query input that includes a wrong fact/concept or information, the system will perform expansion of the recommended search query based on a reliability factor of a candidate recommended search query and a reliability factor of the recommended search query instead of simply correcting a mistyped letter or a grammatical error.

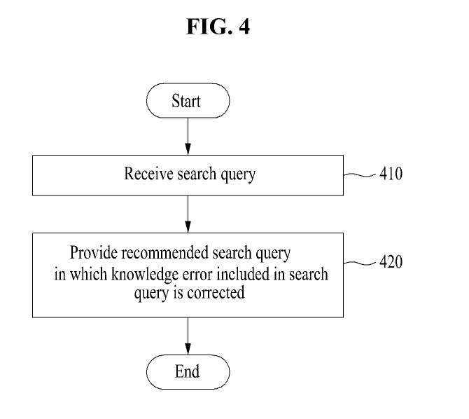

FIG. 4 is a flowchart illustrating an operation of providing a recommended search query in which a knowledge error is corrected based on a knowledge error correcting method according to some example embodiments.

The recommended search query providing operation of FIG. 4 may be performed by the knowledge error correcting system 200 of FIG. 2.

In operation 410, the search engine service provider 214 may receive a search query from a user through the network interface 230.

In an example in which a search application (e.g., a search engine computer program, a search app, a search engine website, etc.) is downloaded and/or accessed by the user using the user terminal 101. For example, the search app may be among applications included in an application store (e.g., appstore) and an installation file corresponding to the search app is installed in the user terminal 101. The search engine service provider 214 may then receive a search query through a search query input screen associated with the search application displayed on the user terminal 101.

In operation 420, when a knowledge error is included in the input search query, the search engine service provider 214 may provide the user terminal 101 with a recommended search query in which the knowledge error is corrected.

In an example in which a knowledge error correction rule that matches the input search query is present among knowledge error correction rules included in the search query recommending database 250 constructed according to the method of FIG. 3, the search engine service provider 214 may display a recommended search query corresponding to the matching knowledge error correction rule on the user terminal 101 through a user interface for a search engine service screen for recommending or suggesting a search query.

FIG. 5 illustrates an operation of generating a recommended search query by combining vocabularies included in the database 250 according to some example embodiments.

Hereinafter, an example in which vocabularies are combined in the database 250 that includes information collected in association with a cinema brand will be described with reference to FIG. 5. In addition, various types of databases that include information collected in various fields may be used to generate a recommended search query and a candidate recommended search query.

Referring to FIG. 5, a cinema database 500 may classify, for each item, and include information collected in association with a cinema brand. For example, the cinema database 500 may classify the collected information into items, such as a cinema name, a cinema address, and a brand type. The cinema database 500 may be implemented within the database 250 of FIG. 2.

The recommended search query generator 211 may generate a recommended search query by combining two or more vocabularies included in the cinema database 500. The recommended search query generator 211 may generate a recommended search query for each domain wherein the domains are associated with the two or more vocabularies.

For example, the recommended search query generator 211 may generate a recommended search query list 510 that includes at least one recommended search query by combining a cinema name (vocabulary 1) 511, such as Megabox, Lotte cinema, and CGV, and location information (vocabulary 2) 512 such as Bundang, Avenuel, and Gyeonggi-do. In this example, the recommended search query generator 211 may generate at least one recommended search query by combining matching vocabularies based on facts among information included in the cinema database 500. In this example, when a domain is a cinema name, the recommended search query generator 211 may generate a recommended search query by combining at least one search keyword and/or search term from the location information domain based on the cinema name, such as the street address of the cinema, the city where the cinema is located, etc. The generated recommended search query may be configured by combining vocabularies corresponding to various types of concepts or information.

In another example, when a celebrity database is used, the recommended search query generator 211 may generate a recommend search query by combining a singing group (vocabulary 1) and the names of the members of the singing group (vocabulary 2). In the same manner, the recommended search query generator 211 may generate a recommended search query by combining vocabularies included in each database, with respect to all of databases constructed for the respective fields, to provide data to be retrieved at a search engine.

As shown in a box 520, the recommended search query generator 211 may expand the recommended search query by normalizing a functional language corresponding to the generated recommended search query.

For example, the recommended search query generator 211 may expand a recommended search query by normalizing a morpheme corresponding to a functional language, a symbol, a region unit, a number, etc. In detail, the recommended search query generator 211 may expand the recommended search query by normalizing “Gyeonggi-do” to “Gyeonggi” 521 and “Namdaemoon-ro 2-ga” to “Namdaemoon-ro” 522.

FIG. 6 illustrates an operation of generating a candidate recommended search query by combining vocabularies included in the database 250 according to some example embodiments.

An example of combining vocabularies in the database 250 that includes information collected in association with a cinema brand will be described with reference to FIG. 6. In addition, various types of databases that include information collected in various fields may be used to generate a recommended search query and a candidate recommended search query.

Referring to FIG. 6, the recommended search query generator 211 may generate a candidate recommended search query for each domain by combining two or more vocabularies included in a database, such as a cinema database 600. The cinema database 600 may be implemented within the database 250 of FIG. 2. Here, the recommended search query generator 211 may generate at least one candidate recommended search query using a combination of vocabularies that are not included in the generated recommended search query.

For example, the recommended search query generator 211 may generate a candidate recommended search query by combining vocabularies that are stored in the cinema database 600 through mutual matching for each item or vocabularies that do not match, regardless of accuracy or inaccuracy of the information included in the cinema database 600. In detail, the recommended search query generator 211 may generate a candidate recommended search query list 610 that includes at least one candidate recommended search query by combining Megabox (vocabulary 1) and Seohyeon (vocabulary 2), by combining Megabox (vocabulary 1) and Namdaemoon-ro (vocabulary 2), and by combining Lotte cinema (vocabulary 1) and Bundang (vocabulary 2).

The verifier and expander 212 may calculate a reliability factor of the generated candidate recommended search query based on a search query log associated with the search engine, the search query log including a history of the search queries submitted by various users of the search engine. When the calculated reliability factor of the candidate recommended search query is greater than a reliability factor of the generated recommended search query, the verifier and expander 212 may expand the candidate recommended search query to the recommended search query.

That is, when a name of a cinema is changed or a new cinema is built, a search query for the cinema may be absent in a recommended search query and a reliability factor of the search query for the cinema may be greater than a reliability factor of a temporarily generated recommended search query. In this example, the verifier and expander 212 may expand the recommended search query by adding the search query for the cinema to the recommended search query list 510.

FIG. 7 illustrates an operation of generating a knowledge error correction rule according to some example embodiments.

The knowledge error correction rule generating operation of FIG. 7 may be performed by the knowledge error correcting system 200 of FIG. 2.

The knowledge error correction rule generator 213 may verify, for each domain, a vocabulary that is estimated to have been input from a user due to erroneous recognition among vocabularies included in a verified and expanded recommended search query, and may generate a rule of generating a wrong answer and correcting the wrong answer to a correct answer.

For example, when a recommended search query is “COEX Megabox” 710 and a domain is “COEX”, the knowledge error correction rule generator 213 may generate a knowledge error correction rule 720 by combining a vocabulary, for example, CGV and Lotte cinema, which is estimated to be input from the user based on wrong information in association with COEX, with COEX that is a domain. In this example, the knowledge error correction rule generator 213 may generate the knowledge error correction rule 720 to match vocabularies 721 that each combine to include a knowledge error and recommended search queries 722 in which the knowledge errors of the combined vocabularies 721 are corrected.

When a search query including a knowledge error is input from the user terminal 101 in a state in which the knowledge error correction rule 720 is generated and the search engine service provider 214 may verify that the input search query includes the knowledge error since the input search query matches the vocabularies 721 based on the knowledge error correction rule 720. The search engine service provider 214 may match the search query including the knowledge error with the vocabularies 721, may correct the generated and/or pre-stored recommended search queries 722, and may provide the user terminal 101 with the recommended search queries 722 in which the knowledge error is corrected. That is, when the search query including the knowledge error is input, the search engine service provider 214 may recommend or suggest the user the recommended search queries 722 in which the knowledge error is corrected.

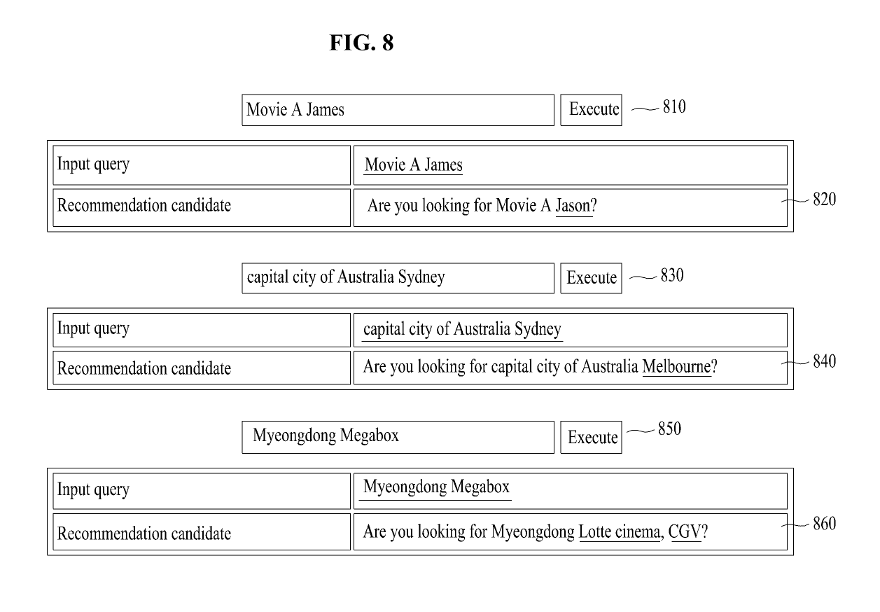

FIG. 8 illustrates an example of providing a recommended search query by correcting a knowledge error included in a search query according to some example embodiments.

Referring to FIG. 8, in an example in which “Movie A James” 810 is input as a search query and submitted to the search engine, the knowledge error correcting system 200 may provide “Movie A Json” 820 as a recommended search query together with the input search query in response.

As another example, when “capital city of Australia Sydney” 830 is input as a search query and submitted to the search engine, the knowledge error correcting system 200 may provide “capital city of Australia Melbourne” 840 as a recommended search query together with the input search query in response.

As another example, when “Myeongdong Megabox” 850 is input as a search query and submitted to the search engine, the knowledge error correcting system 200 may provide “Myeongdong Lotte cinema, CGV” 860 as a recommended search query together with the input search query in response. The knowledge error correcting system 200 may provide at least one recommended search query for the input search query.

The knowledge error correcting system 200 may provide a recommended search query together with a search query input from the user. Thus, the knowledge error correcting system 200 may accurately notify the user of information erroneously recognized by the user and at the same time, may prevent the user from performing an additional operation for a re-search. The knowledge error correcting system 200 may improve a search result quality by conducting a search by using a search query that includes inaccurate, for example, wrong information as a recommended search query that includes accurate, for example, correct information.

Also, the knowledge error correcting system 200 may generate a knowledge error correction rule with respect to all of the databases constructed for the respective fields to provide a search result of data to be retrieved at the search engine, and may provide a recommended search query in which a knowledge error is corrected regardless of a field of the search query.

Further, when the knowledge error is absent in the search query, the knowledge error correcting system 200 may provide a search result for the input search query to the user terminal 101.

As described above with reference to FIGS. 1 through 8, a configuration in which the knowledge error correcting system 200 generates a recommended search query by combining vocabularies included in a database, generates a knowledge error correction rule based on a verified and expanded recommended search query, corrects a search query including a knowledge error based on the generated knowledge error correction rule, and provides the search query in which the knowledge error is corrected may be represented as a normalized form as shown in Table 1.

```
TABLE 1
1. Vocabulary that constitutes a query::
    W={vocabulary indicating a concept or information such as a location,
brand, etc.}
2. User query:
    Q=W₁ ... Wₙ, n=number of vocabularies constituting a query
3. Database for correcting a knowledge error:
    DB_{correct} = {K₁ ... Kₓ}, K=correct answer, x=number of entries
4. Question definition:
                W_{wrong} ∉ DB_{correct} and
        W_{wrong} ∈ Q and {Q ∩ W_{wrong}^{C}} ∈ DB_{correct}
        then replace W_{wrong} To W_{correct} ∈ DB_{correct}
```

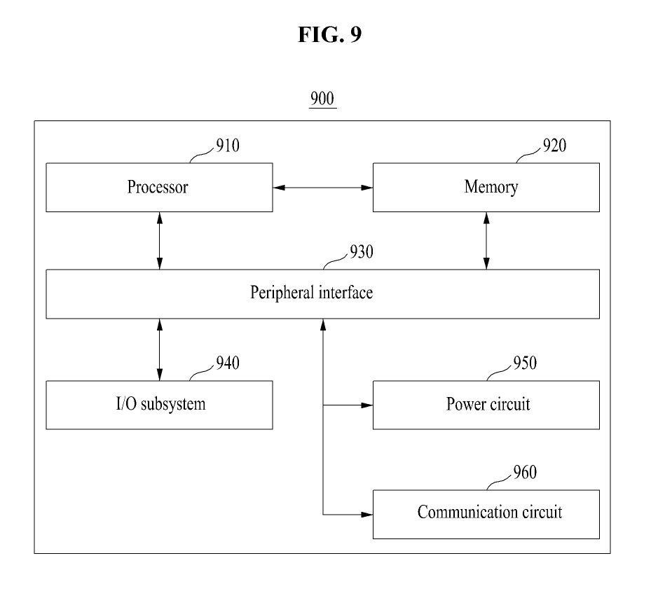

FIG. 9 is a block diagram illustrating an example of a configuration of a computer system 900 according to some example embodiments.

Referring to FIG. 9, the computer system 900 may include at least one processor 910, a memory 920, a peripheral interface 930, an input/output (I/O) subsystem 940, a power circuit 950, and a communication circuit 960. Here, the computer system 900 may correspond to a user terminal.

The memory 920 may include, for example, a high-speed random access memory (HSRAM), a magnetic disk, a static random access memory (SRAM), a dynamic RAM (DRAM), read only memory (ROM), a flash memory, a non-volatile memory, etc. The memory 920 may include a software module, a computer readable instruction set, and/or a variety of data required for an operation of the computer system 900. Here, an access from another component such as the processor 910 and the peripheral interface 930 to the memory 920 may be controlled by the processor 910. The memory 920 may include one or more databases associated with a search engine service.

The peripheral interface 930 may couple an input device and/or output device of the computer system 900 with the processor 910 and the memory 920. The processor 910 may perform a variety of functions for the computer system 900 and process data by executing the software module or the instruction set stored in the memory 920.

The I/O subsystem 940 may couple various I/O peripheral devices with the peripheral interface 930. For example, the I/O subsystem 940 may include a controller for coupling the peripheral interface 930 and a peripheral device such as a monitor, a keyboard, a mouse, a printer, and a touch screen or a sensor depending on a necessity. The I/O peripheral devices may be coupled with the peripheral interface 930 without using the I/O subsystem 940.

The power circuit 950 may supply a power to all of or a portion of components of a terminal. For example, the power circuit 950 may include a power management system, at least one power source such as a battery and alternating circuit (AC), a charge system, a power failure detection circuit, a power converter or inverter, a power status indicator, or other components for creating, managing and distributing power.

The communication circuit 960 enables communication with another computer system using at least one external port. Additionally, as described above, the communication circuit 960 may enable communication with another computer system by including a radio frequency (RF) circuit and thereby transmitting and receiving an RF signal known as an electromagnetic signal.

The example embodiments of FIG. 9 are only an example of the computer system 900. The computer system 900 may have a configuration or an arrangement for omitting a portion of the components illustrated in FIG. 9, further including components not illustrated in FIG. 9, or coupling two or more components. For example, a computer system for a communication terminal of a mobile environment may further include a touch screen, a sensor, and the like, in addition to the components of FIG. 9. A circuit for RF communication using a variety of communication methods, for example, wireless fidelity (Wi-Fi), 3rd generation (3G), long term evolution (LTE), Bluetooth, near field communication (NFC), and ZigBee, may be included in the communication circuit 960. Components includable in the computer system 900 may be configured as hardware that includes an integrated circuit specified for at least one signal processing or application (e.g., ASIC), software, or a combination of hardware and software.

The methods according to the example embodiments may be configured in a program instruction form executable through various computer systems and thereby recorded in non-transitory computer-readable media.

A program according to the example embodiments may be configured as a PC-based program or an application exclusive for a mobile terminal. The search app according to the example embodiments may be configured as an independently operating program form or an in-app form of a specific application to be operable on the specific application.

Further, the methods according to the example embodiments may be performed by controlling, by the search app, a user terminal Such an application may be installed in the user terminal through a file provided from a file distribution system. As an example, the file distribution system may include a file transmitter (not shown) to transmit the file in response to a request from the user terminal.

As described above, according to some example embodiments, although a search query input from a user includes a knowledge error different from actual information or concept, it is possible to provide an accurate search query to the user by correcting the input search query to be a recommended search query indicating correct information and concept. Also, according to some example embodiments, it is possible to solve inconvenience by a re-search and to reduce a search time by correcting a knowledge error indicating an error of information or a concept and by providing a recommended search query in which the knowledge error is corrected.

The example embodiments as disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. A method of correcting a knowledge error in a search query, the method executed on at least one computer, the computer including at least one processor, the method comprising:
generating, using the at least one processor, a recommended search query for a plurality of domains by combining at least one search keyword from each of a plurality of vocabulary sets, each of the plurality of vocabulary sets associated with a respective domain;
verifying, using the at least one processor, the recommended search query based on a reliability factor of the recommended search query; and
generating, for each domain, using the at least one processor, a knowledge error correction rule for correcting a knowledge error indicating an error of a concept or information, with respect to the verified recommended search query.

2. The method of claim 1, further comprising:
receiving, using the at least one processor, a search query; and
providing using the at least one processor, a recommended search query in which the knowledge error is corrected based on the knowledge error correction rule, in response to the received search query including the knowledge error.

3. The method of claim 1, wherein the verifying of the recommended search query comprises:
calculating, using the at least one processor, a reliability factor of a candidate recommended search query generated by combining the at least one search keyword from each of the plurality of vocabulary sets and the reliability factor of the recommended search query;
verifying, using the at least one processor, the recommended search query based on the reliability factor of the recommended search query; and
expanding, using the at least one processor, the candidate recommended search query to the recommended search query by generating a result based on the reliability factor of the candidate recommended search query and the reliability factor of the recommended search query.

4. The method of claim 3, wherein the expanding of the candidate recommended search query to the recommended search query comprises expanding the candidate recommended search query to the recommended search query in response to the reliability of the recommended search query being greater than the reliability of the recommended search query.

5. The method of claim 1, wherein the generating of the recommended search query comprises expanding the recommended search query in response to normalizing a functional language corresponding to the recommended search query.

6. The method of claim 1, wherein the reliability factor of the recommended search query is calculated based on at least one of a search result display frequency, a search query click frequency, and a search frequency corresponding to the recommended search query.

7. A method of correcting a knowledge error in a search query, the method executed on at least one computer, the computer including at least one processor, the method comprising:
receiving, using the at least one processor, a search query; and
displaying, on a search engine service user interface screen, a recommended search query in which a knowledge error is corrected based on a generated knowledge error correction rule, in response to the received search query including the knowledge error indicating an error of a concept or information.

8. The method of claim 7, further comprising:
generating, using the at least one processor, a recommended search query for a plurality of domains by combining at least one search keyword from each of a plurality of vocabulary sets, each of the plurality of vocabulary sets associated with a respective domain;
verifying, using the at least one processor, the recommended search query based on a reliability factor of the recommended search query; and
generating, for each domain, using the at least one processor, the knowledge error correction rule for correcting the knowledge error, with respect to the verified recommended search query.

9. The method of claim 8, wherein the verifying of the recommended search query comprises:
calculating, using the at least one processor, a reliability factor of a candidate recommended search query generated by combining the at least one search term from each of the plurality of vocabulary sets and the reliability factor of the recommended search query;
verifying, using the at least one processor, the recommended search query based on the reliability factor of the recommended search query; and
expanding, using the at least one processor, the candidate recommended search query to the recommended search query based on the reliability factor of the candidate recommended search query and the reliability factor of the recommended search query.

10. The method of claim 7, wherein the displaying comprises displaying the received search query together with the recommended search query on the search engine service user interface screen.

11. A system for correcting a knowledge error in a search query, the system comprising:
a memory having computer readable instructions stored thereon; and
at least one processor configured to execute the computer readable instructions to,
generate a recommended search query for a plurality of domains by combining at least one search keyword from each of a plurality of vocabulary sets, each of the plurality of vocabulary sets associated with a respective domain,
verify the recommended search query based on a reliability factor of the recommended search query, and
generate, for each domain, a knowledge error correction rule for correcting a knowledge error indicating an error of a concept or information, with respect to the verified recommended search query.

12. The system of claim 11, wherein, the at least one processor is further configured to execute the computer readable instructions to:
receive a search query; and
provide a recommended search query in which the knowledge error is corrected based on the knowledge error correction rule, in response to the received search query including the knowledge error.

13. A file distribution system to distribute a file of an application installed in a user terminal, the file distribution system comprising:
a file transmitter configured to transmit the file in response to a user request; and
an application installed on a user terminal, the application including computer readable instructions that, when executed by at least one processor included in the user terminal, configure the user terminal to,
generate a recommended search query for a plurality of domains by combining at least one search keyword from each of a plurality of vocabulary sets, each of the plurality of vocabulary sets associated with a respective domain;
verify the recommended search query based on a reliability factor of the recommended search query; and
generate, for each domain, a knowledge error correction rule for correcting a knowledge error indicating an error of a concept or information, with respect to the verified recommended search query.

14. The file distribution system of claim 13, wherein the computer readable instructions of the application, when executed by the at least one processor included in the user terminal, further configure the user terminal to:
receive a search query; and
provide a recommended search query in which the knowledge error is corrected based on the knowledge error correction rule, in response to the received search query including the knowledge error.
